(19) United States
(12) Patent Application Publication
(10) Pub. No.: US 2012/0073922 A1
(43) Pub. Date: Mar. 29, 2012

(54) Method for controlling a brake system of a motor vehicle and a brake system for a motor vehicle

(76) Inventors: Frank KAESTNER, Bietigheim-Bissingen (DE); Bertram Foitzik, Ilsfeld (DE); Anton Paweletz, Fellbach (DE); Christian Binder, Neckarsulm (DE)

(21) Appl. No.: 13/228,778

(22) Filed: Sep. 9, 2011

(30) Foreign Application Priority Data
Sep. 14, 2010 (DE) 10 2010 040 726.7

(51) Int. Cl. B60T 13/58; B60T 1/06; B60T 13/74

(52) U.S. Cl. 188/70 R; 303/3

(57) ABSTRACT

A brake system for a motor vehicle and a related method includes a hydraulic service brake system, having a brake booster and is operable via a brake operating element, an electric machine, operable as a generator to brake the motor vehicle, and an electromechanical braking device. A setpoint braking torque is determined as a function of a brake pedal travel. The hydraulic service brake system has an idle travel between the brake operating element and a master brake cylinder, in which no braking torque is generated by the vehicle brake system. In the range of the idle travel, the setpoint braking torque is generated by the generator and/or the electromechanical braking device, and a portion of the electromechanical braking device in the setpoint braking torque is modulated as a function of a portion of the generator in the setpoint braking torque so that variations of the generator portion are compensated.

### RELATED APPLICATION INFORMATION

The present application claims priority to and the benefit of German patent application no. 10 2010 040 726.7, which was filed in Germany on Sep. 14, 2010, the disclosure of which is incorporated herein by reference.

### FIELD OF THE INVENTION

The present invention relates to a method for controlling a brake system of a motor vehicle and a brake system for a motor vehicle.

### BACKGROUND INFORMATION

So-called hybrid vehicles having an internal combustion engine and one (or also multiple) electric machines are known, which, depending on the driving situation, are driven by the internal combustion engine, the electric machine operated as a motor, or also jointly by the internal combustion engine and the electric machine. A special feature of hybrid vehicles is the recuperation of braking energy by so-called recuperative braking. The electric machine is operated as a generator and the generated electric power is fed back into an energy storage, such as a battery or a supercapacitor, of the motor vehicle. The energy stored in this way may be retrieved again as needed. The lost power of the motor vehicle during braking is decreased by the recuperation, so that the recuperation accordingly represents a measure for reducing consumption and emissions. However, it is always to be noted that recuperative braking may not have a negative effect on the braking distance.

The generatable braking torque and thus the braking power of the electric machine during generator operation are a function, among other things, of the vehicle speed. The electric machine operated as a generator does not permit constant braking torques until the motor vehicle is at a standstill. Deceleration to a standstill is therefore not possible by recuperative braking alone. During stopping procedures, the hydraulic service brake must therefore compensate for the decreasing brake action of the electric machine. The brake action of the electric machine during generator operation is also a function of the charge state of the energy storage. If the energy storage is fully charged, the electric machine is not available as a brake unit, so that the entire braking torque must be applied via the conventional service brake.

Also, when a clutch is operated in the case of shifting in a non-automatic transmission, the electric machine is mechanically disconnected from the vehicle wheels, if it is not directly associated with the vehicle wheels, so that the brake action is interrupted. An equalization of the brake action of the electric machine during generator operation to the total brake action of the vehicle may be left to a driver. Electronic control of the brake action of the brake system is also possible, for example, which compensates more or less well for the portion of the brake action which the electric machine applies. The control of the brake action of the brake system as a function of the brake action of the electric machine during generator operation may be referred to as “blending.”

A method for regenerative braking of a vehicle is discussed in DE 10 2006055799 A1, in which a setpoint variable, which represents a desired total braking torque, is ascertained and distributed proportionally to at least one electromechanical braking device and a generator, each of which implements a portion of the total braking torque. The portion of the electromechanical braking device is modulated as a function of the portion of the generator in order to compensate for variations of the generator portion.

### SUMMARY OF THE INVENTION

The exemplary embodiments and/or exemplary methods of the present invention provides a method for controlling a brake system of a motor vehicle, which has a hydraulic service brake system, which includes a brake booster and is operable by a driver through muscle power via a brake operating element, an electric machine, which is operable as a generator to brake the motor vehicle, and an electromechanical braking device. A setpoint variable, which characterizes a setpoint braking torque, is determined as a function of a pedal travel of the brake operating element. The hydraulic service brake system has an idle travel between the brake operating element and a master brake cylinder, in which no braking torque is generated by the hydraulic vehicle brake system. In the range of the idle travel, the setpoint braking torque is generated by the generator and/or the electromechanical braking device, a portion of the electromechanical braking device in the setpoint braking torque in the range of the idle travel being modulated as a function of a portion of the generator in the setpoint braking torque in such a way that variations of the generator portion are compensated for.

The exemplary embodiments and/or exemplary methods of the present invention additionally provides a brake system for a motor vehicle having a hydraulic service brake system, which has a brake booster, is operable by a driver through muscle power via a brake operating element, and has an idle travel between the brake operating element and a master brake cylinder, in which no braking torque is generated by the hydraulic vehicle brake system. The brake system additionally includes an electric machine, which is operable as a generator to brake the motor vehicle, and an electromechanical braking device. With the aid of path sensors, a pedal travel of the brake operating element is detected and a setpoint variable which characterizes a setpoint braking torque is determined based thereon. A control unit controls the electric machine and the electromechanical braking device in such a way that the setpoint braking torque in the range of the idle travel is generated by the generator and/or the electromechanical braking device and a portion of the electromechanical braking device in the setpoint braking torque in the range of the idle travel is modulated as a function of a portion of the generator in the setpoint braking torque in such a way that variations of the generator portion are compensated for.

The exemplary embodiments and/or exemplary methods of the present invention provides for blending the varying braking torque generatable by the generator operation of the electric machine in a range of an idle travel, in which the hydraulic vehicle brake system does not generate any braking torque, with a braking torque of an electromechanical braking device. The driver thus perceives a uniform relationship between the force exerted on the brake operating element, e.g., a brake pedal or a brake lever, the pedal travel, and the achieved deceleration of the motor vehicle. More and more motor vehicles are equipped in any case with an electromechanical braking device, which is used as a parking brake. The exemplary embodiments and/or exemplary methods of the present invention may be implemented with extremely low additional technical expenditure for such motor vehicles. Vice versa, the electromechanical braking device required according to the present invention may also be used as a parking brake in motor vehicles which heretofore have had no such braking device.

Through the usage of the muscle power of the driver for the brake pressure buildup, the method according to the present invention and the brake system according to the present invention do not have an increased power requirement, in contrast to a solely power brake system, for example, a brake-by-wire system. However, the brake system is significantly more cost-effective and less complex than a power brake system.

According to a specific embodiment of the present invention, the electromechanical braking device is implemented as a drum brake, which is combined with a hydraulic disc brake. Such brakes are frequently also referred to as DIH brakes (DIH: drum in hat). With the aid of DIH brakes, auxiliary functions such as hill hold control or cruise control systems may also be implemented easily.

According to a specific embodiment of the present invention, it is provided that the brake booster is controlled in such a way that a pedal characteristic, which reflects the functional relationship between pedal force, pedal travel, and brake pressure or braking torque, is achieved as in a solely hydraulic brake application. In this way, the control according to the exemplary embodiments and/or exemplary methods of the present invention does not result in an undesirable change of the accustomed driving or braking feeling of the driver. Since, in the case of a solely hydraulic service brake system, only the hydraulic pressure results in vehicle deceleration, but in the brake system according to the present invention the particular sum of the braking torques of the hydraulic service brake system, the electric machine operated as a generator, and the electromechanical braking device result in vehicle deceleration, in particular the hydraulic pressure must accordingly be decreased to implement a jump-in function of the brake booster in order to achieve an unchanged pedal characteristic.

In order to always ensure the stability of the motor vehicle during a braking procedure, and to reliably prevent the occurrence of pitching movements of the motor vehicle, which are perceived as annoying, independently of the engagement point (front axle or rear axle) of the braking torques of the generator and the electromechanical braking device, the idle travel may be established in such a way that the setpoint braking torque at the end of the idle travel results in a deceleration of the motor vehicle which is less than or equal to 0.1 g.

Further features and advantages of specific embodiments of the present invention result from the following description with reference to the appended figures.

### BRIEF DESCRIPTION OF THE DRAWINGS

FIG. 1 shows a schematic view of a brake system according to the present invention.

FIG. 2 shows a schematic view of a combined hydraulic-electric wheel brake.

FIG. 3 shows a time curve of the braking torques in the range of an idle travel.

FIG. 4 shows a pedal characteristic of the brake system according to the present invention.

FIG. 5 shows a pedal characteristic of a solely hydraulic brake system.

### DETAILED DESCRIPTION

Brake system 1 according to the exemplary embodiments and/or exemplary methods of the present invention shown in FIG. 1 is provided for a motor vehicle (not shown) driven by an electric machine 2. In the exemplary embodiment, electric machine 2 acts on the two wheels (not shown) of a vehicle axle, for example, rear axle 3. Electric machine 2 may also act on all vehicle wheels. A separate electric machine may also be provided for each driven vehicle wheel. For braking, electric machine 2 may be operated as a generator. It may be a motor vehicle driven exclusively by an electric motor (electric vehicle). However, it may also be a so-called hybrid vehicle, which is driven by an internal combustion engine (not shown) and electric machine 2, the drive being able to be performed by the internal combustion engine, electric machine 2, or, for example, for strong acceleration, jointly by the internal combustion engine and electric machine 2, as a function of the driving condition and driving intention. The exemplary embodiments and/or exemplary methods of the present invention are described for an electric machine 2 which is also used as a drive assembly. However, the exemplary embodiments and/or exemplary methods of the present invention is fundamentally also usable with an electric machine 2 which is not used as a drive assembly.

Brake system 1 has a dual-circuit hydraulic service brake system, which acts on the vehicle wheels of both axles of the motor vehicle. The hydraulic service brake system has a master brake cylinder 4 having a brake booster 5. Brake booster 5 may be designed, for example, as a vacuum brake booster or an electric brake booster. Master brake cylinder 5 is operated by muscle power via a brake operating element in the form of a (foot) brake pedal 6.

Hydraulic wheel brakes in the form of disc brakes 8, which are associated with the vehicle wheels on the axles, are connected to master brake cylinder 4 via a hydraulic assembly 7. Hydraulic assembly 7 includes hydraulic components (not shown) of a traction control system, such as a hydraulic pump, brake pressure buildup valves, brake pressure reduction valves, and a hydraulic accumulator. Such hydraulic assemblies are known per se and will therefore not be explained at this point. The hydraulic assembly allows traction control, for example, an antilock braking system, a traction control system, and/or an electronic stability program, for which abbreviations such as ABS, TCS, and ESP are typical.

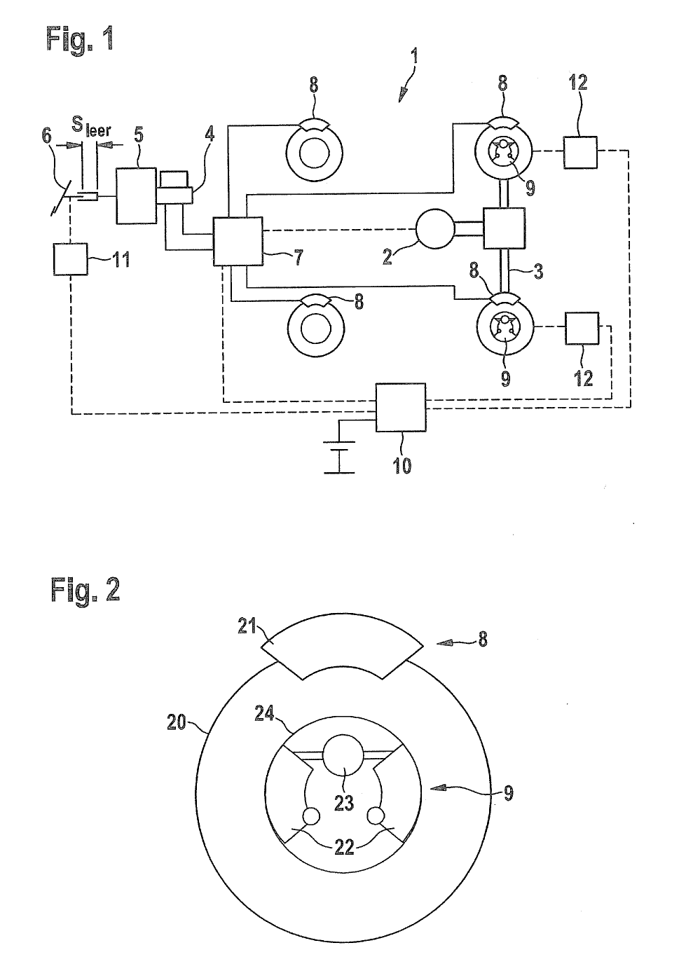

The brake system additionally includes an electromechanical braking device in the form of drum brakes 9, which are associated with the vehicle wheels of rear axle 3. For example, a combined hydraulic-electric brake, which is also referred to as a DIH brake (DIH: drum in hat) is indicated in FIG. 1, and is shown in somewhat greater detail in FIG. 2. The DIH brake includes, in addition to hydraulic disc brake 8 having a brake disc 20 and brake shoes 21, which may operate according to the floating caliper principle, for example, electromechanical drum brake 9. Electromechanical drum brake 9 includes brake shoes 22, which are operated using an electrical drive 23. Brake shoes 22 interact with the friction surface of a brake drum 24, which is connected as a modular unit to brake disc 20. Electromechanical drum brake 9 may also be used as an automatic parking brake or an emergency brake.

To control brake system 1, an electronic control unit 10 is provided, which determines the level of the components of the individual partial brake systems (hydraulic service brake, electric machine 2 operated as a generator, and electromechanical braking device) in a total braking torque and controls the partial brake systems accordingly. Control unit 10 receives signals from diverse sensors, for example, from a path sensor 11, which is associated with brake pedal 6, and force sensors 12, which are associated with drum brakes 9.

The parking brake may be tensioned as needed by force sensors 12 on drum brakes 9. This reduces the high load changes of a parking brake without a sensor, which is always tensioned using maximum tension force.

The hydraulic service brake system has an idle travel s_{idle} between brake pedal 6 and master brake cylinder 4. In this idle travel s_{idle}, no hydraulic brake pressure is built up, and therefore also no hydraulically generated friction braking torque. Operation of brake pedal 6 and therefore a driver's braking intention is recognized by path sensor 11 and, as a function of an operating travel of the brake pedal, a setpoint braking torque or at least a setpoint variable which characterizes the setpoint braking torque is determined. The setpoint braking torque in idle travel s_{idle} may not be generated by the hydraulic brake system and is instead implemented by electric machine 2 and/or electromechanical drum brake 9. A portion of electromechanical drum brake 9 in the setpoint braking torque in the range of idle travel s_{idle} is modulated by control unit 10 as a function of a portion of the generator in the setpoint braking torque in such a way that variations of a generator portion are compensated for. In this way, the braking torque of electric machine 2 is completely “blended.” The load profile of drum brake 9 is improved by the blending in spite of more frequent operation.

Idle travel s_{idle} is established in such a way that the setpoint braking torque at the end of idle travel s_{idle} results in a deceleration of the motor vehicle which is less than or equal to 0.1 g. The maximum generator torque is thus limited to at most 0.1 g. If the electromechanical braking device and electric machine 2 operated as a generator act on the vehicle wheels of the same axle, such as rear axle 3 (see FIG. 1), no pitching movement occurs during the changeover (blending) of the braking torque. Electric machine 2 frequently also acts on the front axle, however, because it represents the drive axle. In contrast, the electromechanical braking device acts on rear axle 3 because of its use as the parking brake. In this case, a pitching movement occurs during the changeover of the braking torque. Experience has shown that the pitching movement is not perceived as annoying in the case of decelerations up to 0.1 g. Furthermore, it is also advisable for stability reasons not to apply decelerations greater than 0.1 g solely to rear axle 3.

In the range of idle travel s_{idle}, there is no brake pressure and therefore also no hydraulic brake action. In this range, the setpoint braking torque or total braking torque Mₜₒₜₐₗ is generated by electromechanical drum brake 9 and/or electric machine 2, which is operated as a generator. The sum of these electrically generated braking torques is referred to hereafter as Mₑₗ. The following equation applies:

Mₑₗ=M_{DIH}+M_{gen}
where M_{DIH}: braking torque of the electromechanical braking device
M_{gen}: braking torque of the generator

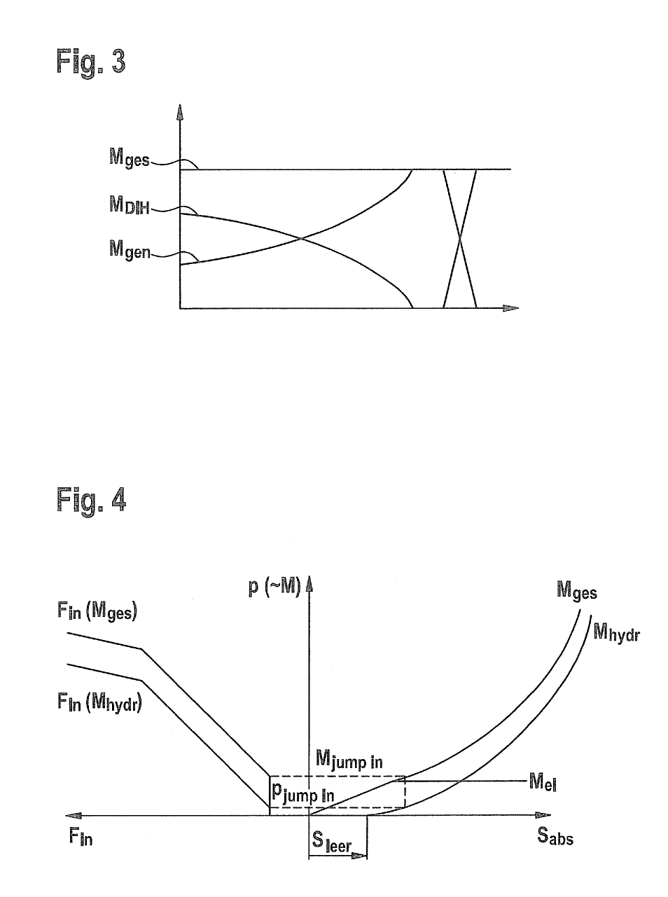

FIG. 3 shows the time curve of setpoint braking torque Mₜₒₜₐₗ, braking torque M_{gen} generated by the generator, and braking torque M_{DIH} generated by the electromechanical braking device in the range of idle travel s_{idle}. Depending on the operating point of the generator, braking is performed by the generator, using the electromechanical braking device, or from a mixture of the two braking torques.

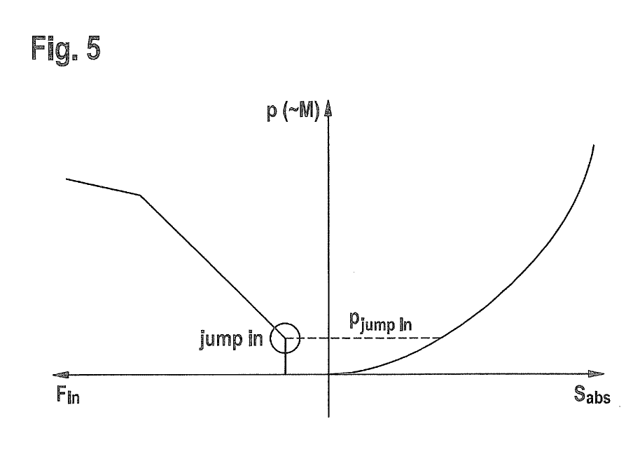

FIG. 4 shows a pedal characteristic of brake system 1 according to the present invention, which reflects the functional relationship between pedal force Fᵢₙ, pedal travel s_{abs} and brake pressure p and braking torque M. So as not to change the pedal characteristic in comparison to a conventional solely hydraulic system (see FIG. 5), the characteristic variables of the characteristic curve of a conventional brake booster must remain unchanged. Since only the hydraulic pressure results in deceleration in the case of the solely hydraulic system, but in the case of brake system 1 according to the present invention it is the sum of the hydraulic and electrical systems, hydraulic pressure pⱼᵤₘₚ₋ᵢₙ upon jump in must be reduced in comparison to a conventional solely hydraulic brake system. In this way, the jump-in function of brake booster 6 remains unchanged in comparison to a solely hydraulic system. The driver sets a (total) setpoint braking torque Mₜₒₜₐₗ via brake pedal 6, as is typical from the conventional brake system. Total braking torque Mₜₒₜₐₗ results from the sum of hydraulically generated braking torque M_{hyd} and electrically generated braking torque Mₑₗ.

What is claimed is:

1. A method for controlling a brake system of a motor vehicle, comprising:
a hydraulic service brake system, which includes a brake booster and which is operable by a driver through muscle power via a brake operating element;
an electric machine, which is operable as a generator to brake the motor vehicle; and
an electromechanical braking device;
wherein a setpoint variable, which characterizes a setpoint braking torque, is determined as a function of a pedal travel of the brake operating element,
wherein the hydraulic service brake system has an idle travel between the brake operating element and a master brake cylinder, in which no braking torque is generated by the hydraulic vehicle brake system,
wherein the setpoint braking torque in the range of the idle travel is generated by at least one of the generator and the electromechanical braking device, and
wherein a portion of the electromechanical braking device in the setpoint braking torque in the range of the idle travel is modulated as a function of a portion of the generator in the setpoint braking torque so that variations of the generator portion are compensated for.

2. The method of claim 1, wherein the brake booster is controlled, including with respect to a jump-in function, so that a pedal characteristic is achieved as in the case of a solely hydraulic braking procedure.

3. The method of claim 1, wherein the idle travel is established so that the setpoint braking torque at the end of the idle travel results in a deceleration of the motor vehicle which is less than or equal to about 0.1 g.

4. A brake system for a motor vehicle, comprising:
a hydraulic service brake system, which has a brake booster, which is operable by a driver through muscle power via a brake operating element and which has an idle travel between the brake operating element and a master brake cylinder, in which no braking torque is generated by the hydraulic vehicle brake system;
an electric machine, which is operable as a generator to brake the motor vehicle;
an electromechanical braking device;
a path sensor, by which a pedal travel of the brake operating element is detected and, based thereon, a setpoint variable which characterizes a setpoint braking torque is determined; and
a control unit, which controls the electric machine and the electromechanical braking device so that the setpoint braking torque in the range of the idle travel is generated by at least one of the generator and the electromechanical braking device, and a portion of the electromechanical braking device in the setpoint braking torque in the range of the idle travel is modulated as a function of a portion of the generator in the setpoint braking torque so that variations of the generator portion are compensated for.

5. The brake system of claim 4, wherein the electromechanical braking device is a drum brake, which is combined with a hydraulic disc brake.

6. The brake system of claim 4, wherein the electromechanical braking device is also used as a parking brake.
